(19) United States
(12) Patent Application Publication
(10) Pub. No.: US 2009/0089697 A1
(43) Pub. Date: Apr. 2, 2009

(54) Configurable User Interface Systems and Methods for Machine Operation

(75) Inventor: Timothy Peder LOUCKS, Shelburne, VT (US)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd., Bolton (CA)

(21) Appl. No.: 11/864,387

(22) Filed: Sep. 28, 2007

(51) Int. Cl. G06F 3/048

(52) U.S. Cl. 715/771

(57) ABSTRACT

A system and method configuring a machine controller to control a selected piece of molding machine equipment may comprise presenting to a user a first set of pieces of molding machine equipment, presenting to the user a set of graphical user interface (GUI) formats associated with a second set of pieces of molding machine equipment by at least one manufacturer of the second set of pieces of molding machine equipment, selecting at least one piece of molding machine equipment to be controlled by the molding machine control apparatus from the first set of pieces of molding machine equipment, selecting a GUI format from the set of GUI formats, and configuring a GUI of the machine controller to control the selected piece of molding machine equipment based on the selected GUI format.

### TECHNICAL FIELD

The present disclosure relates to configurable user interface systems and methods for machine control operation.

### BACKGROUND INFORMATION

Molding machines may feature one or more machine controllers configured to control and/or monitor the operation and processes of one or more aspects of a molding system, such as an injection molding machine (IMM) for plastic or metal, and its associated equipment, for example, but not limited to, a hot runner, a robot or other product handling equipment. Machine controllers may include a human machine interface or graphical user interface (GUI), which allow users to interact with the machine controller and computer-controlled devices. Such interfaces may include a display, an optional pointing device, pushbuttons, as well as graphical icons, visual indicators or special graphical elements called “widgets”, along with text, labels or text navigation to represent the information and actions available to a user and to provide the functions for data entry, screen selections, machine operation selection and actuation of manual operations.

As the injection molding processes become more complex, the demand for more functions and operations to be provided by a machine controller may also increases. For example, processing molds with multiple cavities or complicated parts may include an increasing number of mold functions (such as multiple ejectors and air blow functions for parts removal, and multiple core actuators to form complicated parts) in addition to the basic machine functions. This may impose a burden on the operator to find the right buttons to push during manual operation resulting in a steep, operator/user learning curve.

Additionally, IMM systems may include a plurality of components which may include a GUI that are unique to a specific brand or model. Users of the IMM system may become accustomed to using one type of GUI for a specific type of IMM equipment. As a result, the purchase of new IMM equipment may incur a high switching cost because retraining may be required to familiarize the users with the new GUI.

It is important to note that the present disclosure is not intended to be limited to a system or method which must satisfy one or more of any stated or implied objects or features of the invention. It is also important to note that the present disclosure is not limited to the preferred, exemplary, or primary embodiment(s) described herein. Modifications and substitutions by one of ordinary skill in the art are considered to be within the scope of the present disclosure, which is not to be limited except by the following claims.

### SUMMARY

According to one aspect, the present disclosure may feature a method of controlling a piece of molding machine equipment comprising selecting at least one piece of molding machine equipment forming at least part of a molding machine, selecting at least one graphical user interface (GUI) format from a plurality of GUI formats, and configuring a GUI of a machine controller to control the selected piece of molding machine equipment based on the selected GUI format.

According to another aspect, the present disclosure may feature a method of controlling a piece of molding machine equipment comprising presenting to a user a first set of molding machine equipment; presenting to the user a set of graphical user interface (GUI) formats associated with a second set of pieces of molding machine equipment by at least one manufacturer of the second set of pieces of molding machine equipment; selecting at least one piece of molding machine equipment to be controlled by the molding machine control apparatus from the first set of pieces of molding machine equipment; selecting a graphical user interface format from the set of GUI formats; and configuring a GUI of a machine controller to control the selected piece of molding machine equipment based on the selected GUI format.

According to yet another aspect, the present disclosure may feature an article comprising a storage medium having stored thereon instructions that when executed by a machine result in the following: presenting to a user a first set of pieces of molding machine equipment; presenting to the user a set of graphical user interface (GUI) formats associated with a second set of pieces of molding machine equipment by at least one manufacturer of the second set of pieces of molding machine equipment; selecting at least one piece of molding machine equipment to be controlled by the molding machine control apparatus from the first list of pieces of molding machine equipment; selecting a GUI format from the set of GUI formats; and configuring a GUI of a machine controller to control the selected piece of molding machine equipment based on the selected GUI format.

In a further aspect, the present disclosure may feature a system comprising at least one piece of molding machine equipment forming at least part of a molding machine system and a machine controller. The machine controller may comprise a display and a storage medium having stored thereon instructions that when executed by the machine controller, result in configuring a graphical user interface (GUI) of the machine controller to control the piece of molding machine equipment based on a user selection of a GUI format.

According to another aspect, the present disclosure may feature a machine controller apparatus comprising a display and a storage medium having stored thereon instructions that when executed by the machine controller, result in configuring a graphical user interface (GUI) of the machine controller to control the piece of molding machine equipment based on a user selection of a GUI format.

### BRIEF DESCRIPTION OF THE DRAWINGS

These and other features and advantages of the present disclosure will be better understood by reading the following detailed description, taken together with the drawings wherein:

FIG. 1 is a schematic of an injection molding machine (IMM) system according to the present disclosure;

FIG. 2 is a flow chart showing operations consistent with one embodiment of the present disclosure;

FIG. 3 is a flow chart showing operations consistent with another embodiment of the present disclosure;

FIGS. 4-8 are screen shots of one embodiment of a control program consistent with the operations of the present disclosure; and

FIG. 9 is a block diagram illustrating one embodiment of circuitry for executing the operations consistent with the operations of the present disclosure.

### DETAILED DESCRIPTION

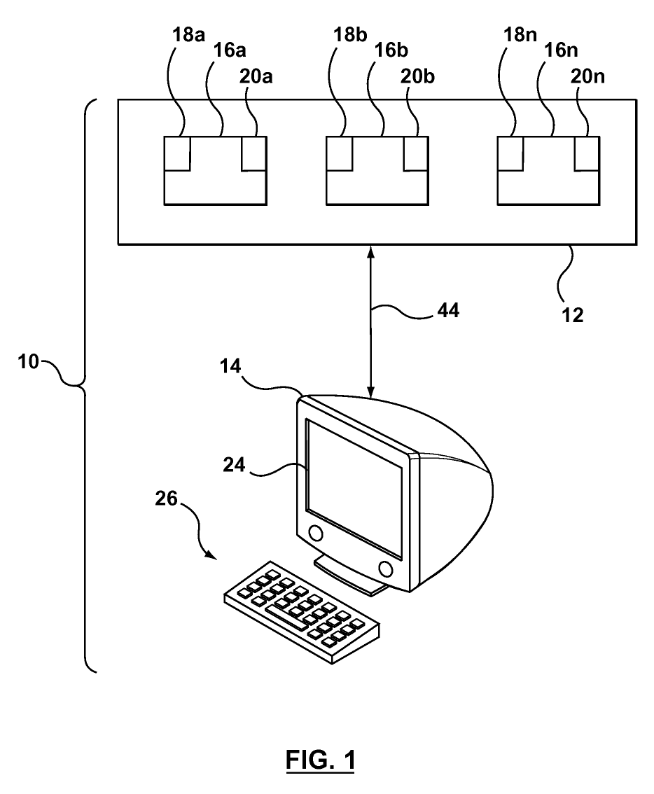

Referring to FIG. 1, one embodiment of a schematic injection molding machine (IMM) system 10 is shown. The IMM system 10 may include an IMM apparatus 12 (for example, but not limited to, the systems described in U.S. Pat. No. 6,275,741 entitled Integrated Control Platform for Injection Molding System which is fully incorporated herein by reference) and one or more machine controllers 14 (only one of which is shown for clarity). The IMM apparatus 12 may include one or more pieces of IMM equipment 16a-16n which comprise, at least in part, one or more operations, functions or processes of the IMM apparatus 12.

The IMM equipment 16a-16n may include any device forming a part of the IMM apparatus 12 including, but not limited to, hot runners, robots, driers, valves, injection units, data acquisition units, heaters, coolers, nozzles, actuators (such as but not limited to, hydraulic actuators, pneumatic actuators, electric actuators, or electromagnet actuators) and the like. One or more of the pieces of IMM equipment 16a-16n may optionally include at least one analog 18a-18n and/or digital devices 20a-20n. Each of the analog 18a-18n and/or digital 20a-20n devices may include input for driver control and an output which provides feedback signals used in open or closed loop control of the device 16a-16n. Analog devices 18a-18n and digital devices 20a-20n may be configured to receive control signals from, and output feedback signals to, the machine controller 14 either wirelessly or across a bus 44 or the like. The analog devices 18a-18n and digital devices 20a-20n may be collectively referred to as input/output devices.

The machine controller (or control panel or station) 14 may be configured to control and/or monitor the operation and/or processes of one or more pieces of the IMM equipment 16a-16n. For example, the machine controller 14 may be used by the operator to input control data and/or to view process feedback information. The machine controller 14 may include a display 24 and one or more I/O devices 26 such as, but not limited to, buttons (for example a keyboard or the like), pointing device (for example a mouse or the like), touch pads, touch screens, or the like to represent the information and actions available to a user and to provide the functions for data entry, screen selections, machine operation selection and actuation of manual operations. The machine controller 14 may be configured to represent or simulate a specific type or format of GUI associated with one or more pieces of IMM equipment. The simulated GUI format may be different from the GUI format of the actual or intended piece of IMM equipment forming part of the actual or intended IMM system which the machine controller is associated. For illustrative purposes only, the machine controller 14 according to the present application may be configured to represent or simulate the GUI format of at least one piece of IMM equipment which was replaced with a different piece of IMM equipment 16a-16n.

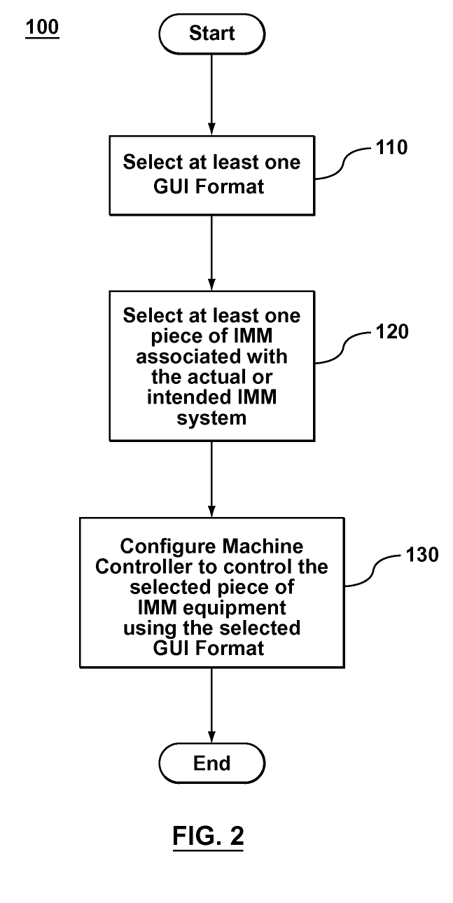

FIG. 2 shows a flowchart 100 illustrating one method consistent with the present disclosure. Flowchart 100 depicts operations that may be used to allow a user to configure a machine controller (such as, but not limited to, machine controller 14 of FIG. 1) to represent or simulate a specific type or format of GUI associated with one or more pieces of IMM equipment. For example, the operations may include selecting at least one GUI format associated with a specific piece of IMM equipment (110) to be simulated. As noted above, the GUI format associated with the specific piece of IMM equipment to be simulated may not correspond to the GUI associated with any of the pieces of IMM equipment forming part of the actual or intended IMM system in which the machine controller is to be used. The operations may also include selecting at least one piece of IMM equipment which will be used in at least part of the actual or intended IMM system and which the machine controller is to control (120). The selected piece of IMM equipment in which the machine controller is to control may be different from the specific piece of IMM equipment associated with the GUI format to be simulated. The machine controller may then be configured to control the selected piece of IMM equipment to be used in the actual or intended IMM system based on the GUI format associated with the selected piece of IMM equipment to be simulated (130). Accordingly, the machine controller may include a GUI format associated with a different piece of IMM equipment other that the selected piece of IMM equipment to be used in the actual IMM system.

As used herein, the term “GUI format” and the like is intended to refer to the general layout, organization, and labeling of the various functions of a machine controller graphical user interface such as, but not limited to, the display, pointing devices, pushbuttons, as well as graphical icons, visual indicators or special graphical elements called “widgets”, along with text, labels or text navigation to represent the information and actions available to a user and to provide the functions for data entry, screen selections, machine operation selection and actuation of manual operations. The term “simulate” or “represent” as used herein does not necessarily mean that the GUI format is exactly the same as the actual, selected GUI format. Instead, the term “simulate” or “represent” is intended to mean that the GUI format to be simulated or represented is generally based on the selected GUI format. The exact layout, organization, and labeling of the GUI format to be simulated or represented will depend on the available space and arrangement of the machine controller.

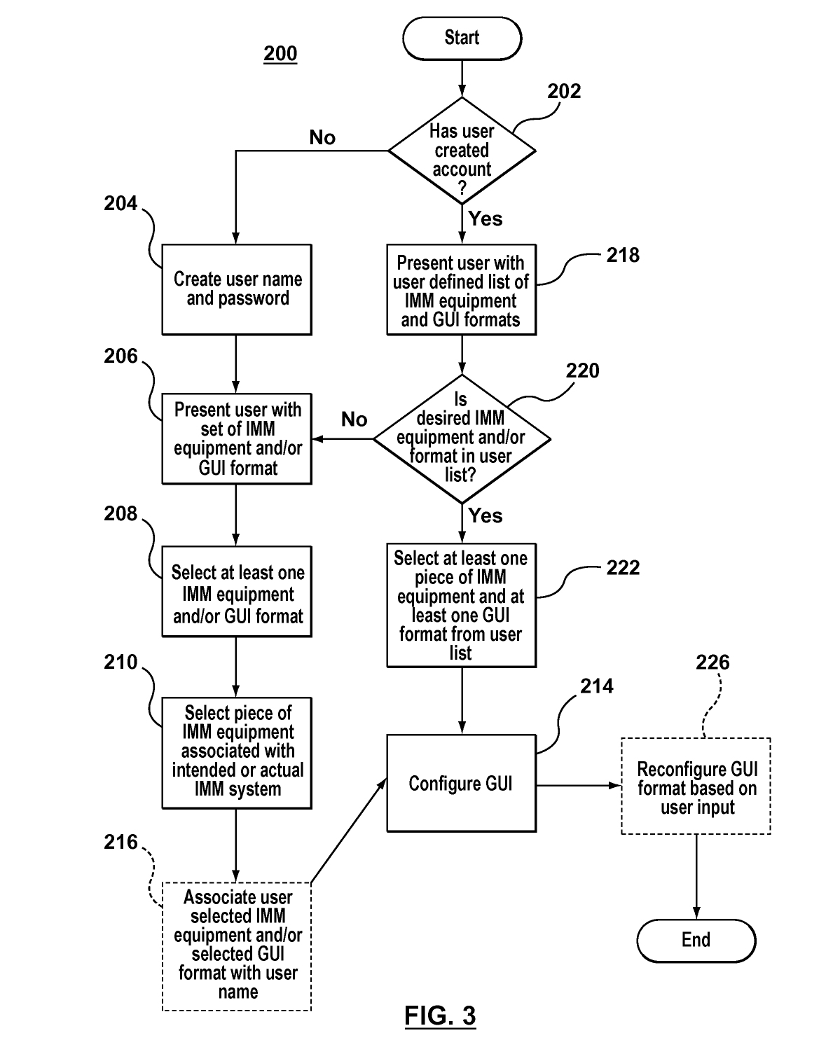

One embodiment of the method illustrated in FIG. 2 is further shown in FIG. 3. The method 200 may include determining whether a user has created a user account (202). If the user has not created a user account, the user may be asked to create a user name and, optionally, a password (204). Operations may also include presenting the user with a set of IMM equipment (206) and selecting at least one IMM equipment (208) and/or GUI format which the user would like the machine controller GUI to represent or simulate. The set of IMM equipment presented to the user may include a plurality of pieces of IMM equipment which may be associated with an IMM system. The piece of IMM equipment and/or GUI format selected by the user may not actually be part of the IMM system.

For example, the user may be presented with a hierarchal list of possible pieces IMM equipment from which to select. According to one embodiment, the user may be presented with a set of possible types or categories of IMM equipment which may be present in the IMM system. For example, the type or categories of IMM equipment may include, but are not limited to, nozzles, heaters, extruders, or the like. The user may then select one or more types or categories of IMM equipment from the list and may be presented with a list of manufacturers. The list of manufactures presented to the user may be based, at least in part, on the user's selection(s) of the type or category of IMM equipment. The user may then select one or more manufacturers and may be presented with a list of models of IMM equipment. Again, the list of models presented to the user may be based on, at least in part, on the user's selection of the manufacture. This process may continue until the user selects at least one specific type (e.g., model) of IMM equipment and, ultimately, a GUI format associated with that specific type of IMM equipment which the user would like the machine controller to represent or simulate. Other methodologies for presenting and selecting the specific type of IMM equipment and GUI format may also be utilized. For example, the user may enter a model, serial number, or other identifying words, symbols, or like and a computer program may perform a search of a the available IMM equipment database and provide the user with one or more likely matches.

The operations may also include selecting at least one specific piece of IMM equipment that may form at least part of the actual or intended IMM system that the machine controller will control (210). The piece of IMM equipment selected in this operation should correspond to at least one of the actual or intended pieces of IMM equipment in the IMM system with which the machine controller is to be associated. Thereinafter, the desired GUI format may be associated with the actual piece of IMM equipment associated with the intended or actual IMM system (212) and the machine controller may be configured to control the actual piece of IMM equipment using the selected GUI format (214). Optionally, the selected GUI format and/or the selected piece of IMM equipment may be saved and associated with the user name (216).

In the event that a user name has been created, the operations may include presenting (218) the user with a list of at least one piece of IMM equipment and/or at least one GUI format previously associated with the user name as described in operation 216. The operations may also include determining (220) whether the desired IMM equipment and/or GUI format are in the list presented to the user in operation 218. If the desired IMM equipment and/or GUI format are not in the list presented to the user in operation 218, then the user may select a desired piece of IMM equipment and/or GUI format as generally described in operations 206-216. If the desired IMM equipment and GUI format are in the list presented to the user in operation 218, then the user may select (222) at least one of the IMM equipment to be associated with at least one of the GUI formats in the list presented to the user in operation 218 and the machine controller may be configured to control the selected piece of IMM equipment using the selected GUI format (214).

Optionally, the operations may also include reconfiguring at least part of the selected GUI format of the machine controller based on user preferences (226), for example as described in U.S. Pat. No. 6,684,264 entitled Method of Simplifying Machine Operation, which is fully incorporated herein by reference. For example, the user may reconfigure at least part of the selected GUI to customize the GUI which may be unique to the user.

Embodiments of the methods described above may be implemented in a computer program that may be stored on a storage medium having instructions to program a system to perform the methods. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions. Other embodiments may be implemented as software modules executed by a programmable control device.

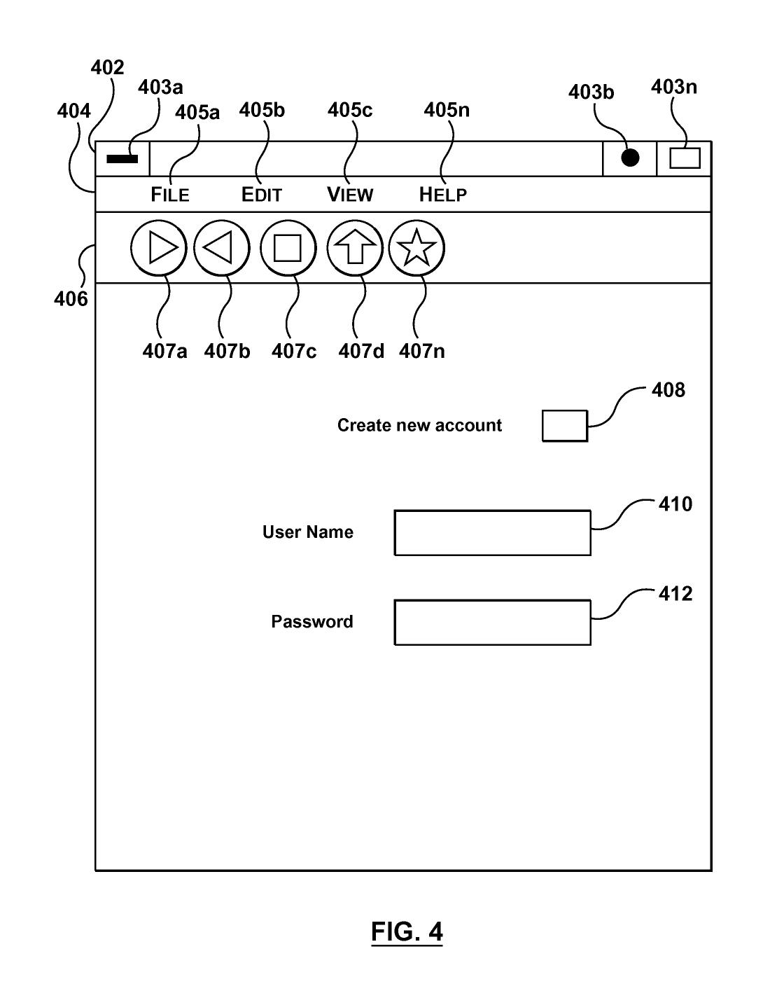

Referring now to FIGS. 4-8, an illustrative embodiment of various screen shots consistent with a computer program according to the present disclosure are shown that may be used to configure the GUI format of a machine controller. The computer program may include a header 402 including one or more icons 403a-n, for example for minimizing the screen 403a, closing the screen 403b, and maximizing the screen 403n. The program may also include a menu bar 404 including one or more menus 405a-n and optionally may include a navigation menu 406 including one or more navigational icons 407a-n.

Referring now specifically to FIG. 4, one embodiment of a log-in screen is shown. The log-in screen may include an input 408 in which a user may create a new account. The log-in screen may also include a user account box 410 in which a user may enter a user name (for example, a user name that was previously established). Optionally, the log-in screen may include a password box 412 in which a user may be required to enter a password associated with the user name.

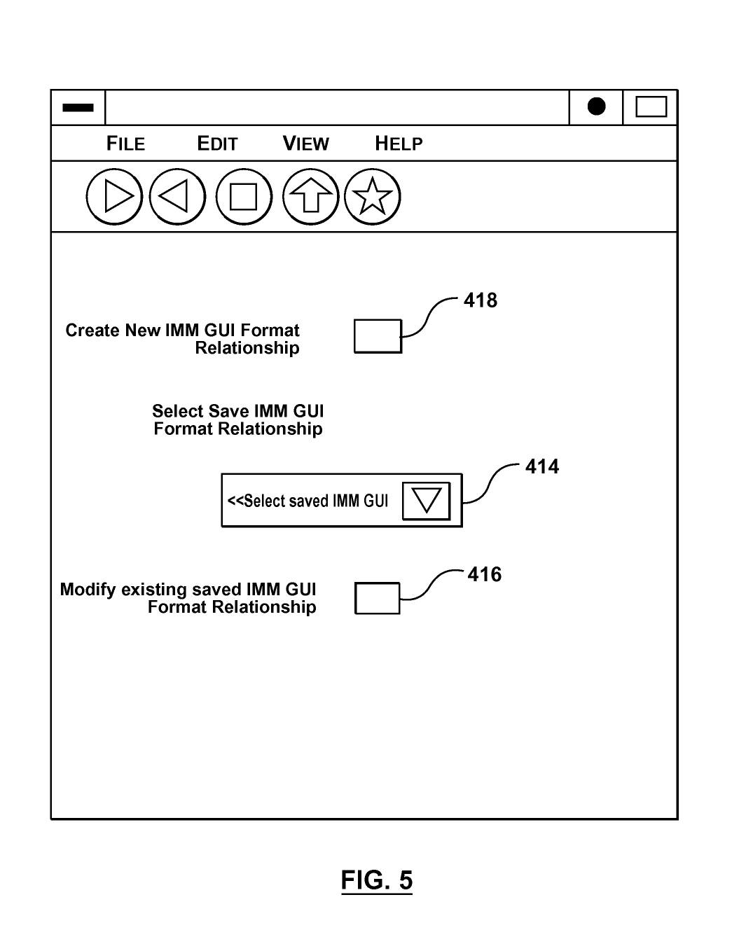

Referring to FIG. 5, the program may allow a user to select a saved IMM GUI format relationship (for example, an IMM GUI format relationship previously associated with the user name between a specific piece of IMM equipment and a selected GUI format) using drop down menu 414. Optionally, the program may allow a user to modify an existing or saved IMM GUI format relationship using field 416. The program may also allow the user to create a new IMM GUI format relationship using field 418.

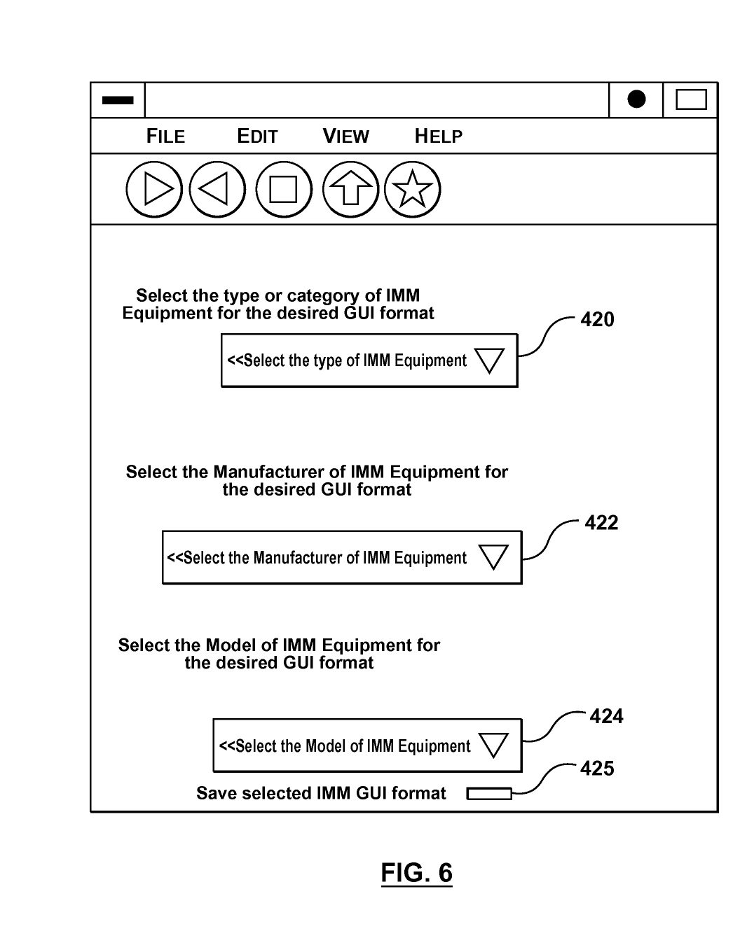

FIGS. 6-8 show one embodiment for selecting and creating a new IMM GUI format relationship. For example, FIG. 6 shows one embodiment for selecting the desired GUI format to be presented by the machine controller for control of a selected piece of IMM equipment. For example, the program may be configured to allow a user to select a type or category of IMM equipment for the desired GUI format using drop-down menu 420. Using drop-down menu 422, the program may allow a user to select a Manufacturer of IMM equipment for the desired GUI format. Additionally, the program may allow a user to select a model of IMM equipment for the desired GUI using drop-down menu 424. As discussed above, the program may be configured to sort the options presented in the various menus 420, 422, 424 based on one or more selections from the various menus 420, 422, 424 to facilitate the selection of a specific GUI format (for example, a specific GUI format associated with a specific model of IMM equipment). The selected GUI format may not correspond to the GUI format developed by the manufacturer of the actual or intended piece of IMM equipment in the IMM system. The program may also be configured to allow the user to select the model of IMM equipment or GUI format directly from the entire list of possible IMM equipment and/or GUI formats. The program may also be configured to allow the user to save the selected GUI format and optionally have the selected GUI format be associated with the user name, for example, using box 425.

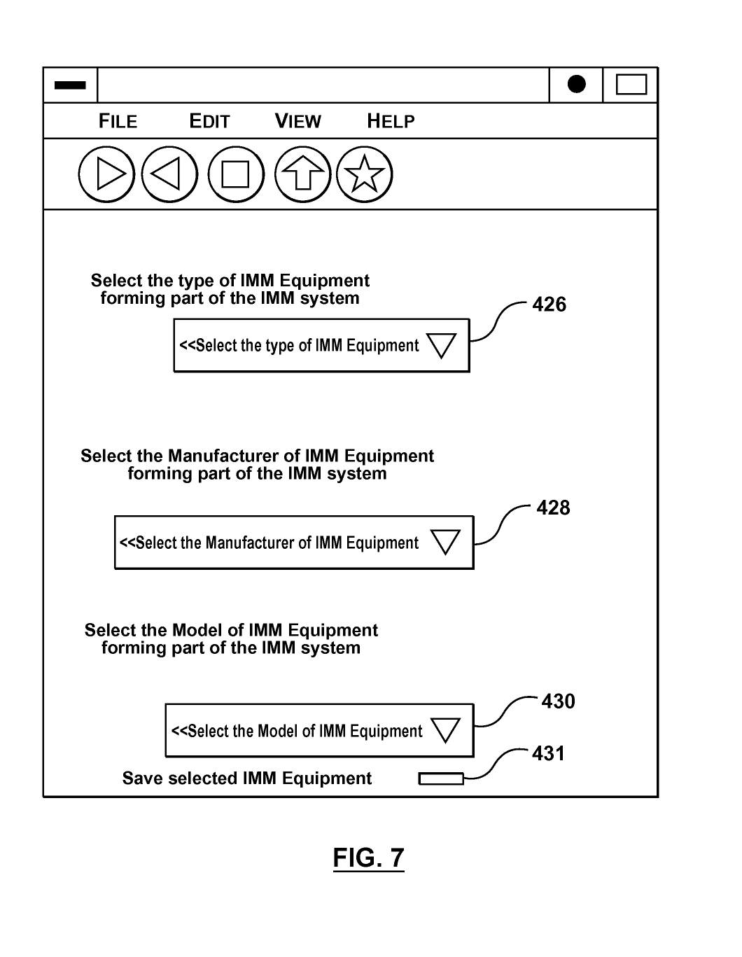

FIG. 7 shows one embodiment for selecting the desired piece of IMM equipment forming part of the IMM system which is to be controlled by the machine controller. Using drop-down menu 426, the program may allow a user to select a type or category of IMM equipment forming part of the IMM system to be controlled by the machine controller. Using drop-down menu 428, the program may allow a user to select a Manufacturer of IMM equipment forming part of the IMM system. Additionally, the program may allow a user to select a model of IMM equipment forming part of the IMM system using drop-down menu 430. As discussed above, the program may be configured to sort the options presented in the various menus 426, 428, 430 based on one or more selections from the various menus 426, 428, 430 to facilitate the selection of a specific piece of IMM equipment forming part of the actual or intended IMM system. The selected piece of IMM equipment may not include a GUI format created by the manufacturer that corresponds to the GUI format selected in the previous screen. The program may also be configured to allow the user to select the model of IMM equipment directly from the entire list of possible IMM equipment. The program may be configured to allow the user to save the selected piece of IMM equipment and optionally have the selected piece of IMM equipment be associated with the user name, for example, using box 431.

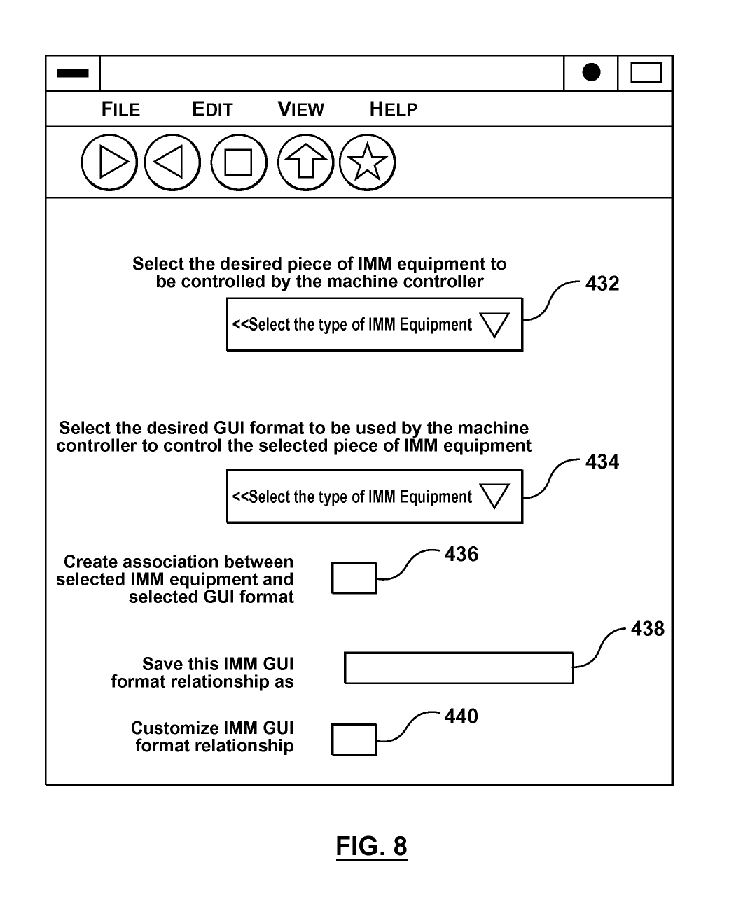

FIG. 8 shows one embodiment of the program for creating a GUI format relationship between the selected GUI format and the selected piece of IMM equipment forming part of the actual or intended IMM system. For example, the program may allow a user to select the desired piece of IMM equipment to be controlled by the machine controller using, for example, drop-down menu 432. The selected piece of IMM equipment should correspond to at least one piece of IMM equipment of IMM system in which the machine controller is associated. Additionally, the program may be configured to present a list of IMM equipment based on, at least in part, the IMM equipment associated with the user name. The program may also be configured to present a list of all IMM equipment associated with the machine controller.

The program may also allow a user to select the desired GUI format to be used by the machine controller to control the selected piece of IMM equipment, for example, by way of drop-down menu 434. The program may be configured to present a list of GUI formats based on, at least in part, the GUI formats associated with the user name. The program may also be configured to present a list of all GUI formats associated with the machine controller.

The program may be configured to allow a user to create an association or relationship between the selected piece of IMM equipment shown in menu 432 and the selected GUI format shown in menu 434, for example using button 436, and may optionally allow the user to save the IMM equipment/GUI format relationship with an associated name using, for example, box 438. Optionally, the program may be configured to allow a user to customize and/or reconfigure at least part of the selected GUI format of the machine controller based on user preferences using button 440. The program may customize and/or reconfigure at least part of the GUI format as described in U.S. Pat. No. 6,684,264 entitled Method of Simplifying Machine Operation, which is fully incorporated herein by reference. For example, the user may reconfigure at least part of the selected GUI format to customize the GUI format which may be unique to the user.

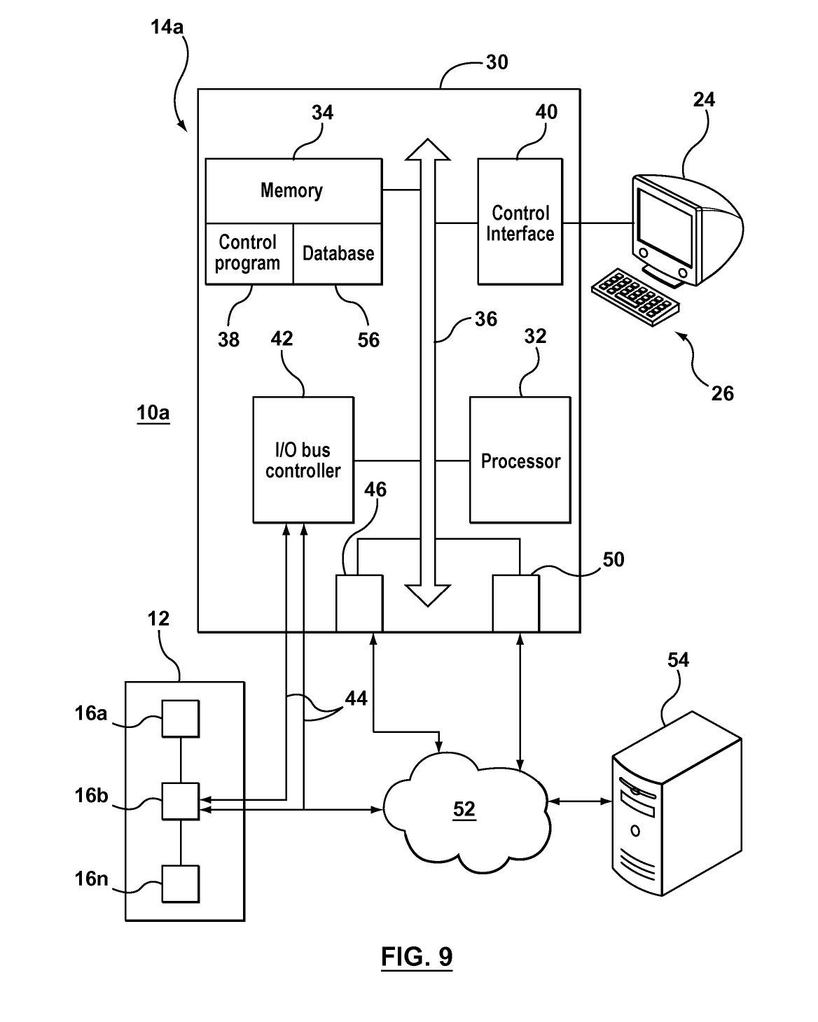

Referring now to FIG. 9, one embodiment of a schematic diagram of a processor-based machine controller 14a for implementing the method and computer program according to the present application is shown. As used in any embodiment described herein, “circuitry” may comprise, for example, singly or in any combination, hardwired circuitry, programmable circuitry, solid-state machine circuitry, and/or firmware that stores instructions executed by programmable circuitry. It should be understood at the outset that any of the operations and/or operative components described in any embodiment herein may be implemented in software, firmware, hardwired circuitry and/or any combination thereof.

The machine controller 14a may comprise a control computer 30 such as, but not limited to, a general purpose computer having a CPU or processor 32 coupled to memory 34 (such as, but not limited to, one or more conventional memory devices including, without limitation, dynamic random access memories (DRAMs), extended data out DRAMs (EDO DRAMs), burst extended data out DRAMs (BEDO DRAMs), static random access memories (SRAMs), video random access memories (VRAMs), read-only memories (ROMs), electrically erasable programmable read-only memories (EEPROMs), and erasable programmable read-only memories (EPROMS) and the like) across a host bus 36. One or more control programs 38 may be stored in memory 34. The control programs 38 may be executed by the processor 32 to control the processor-based machine controller 14a and/or one or more of the IMM equipment 16a-16n as generally described herein.

A control panel interface 40 may be configured to be coupled to the host bus 36 as well as a display 24 and one or more I/O devices 26 (such as, but not limited to, peripherals including a CRT, a keyboard, a disk drive, a CD-ROM drive, a mouse, a touch screen, a light pen, etc). The control panel interface 40 may include a Beckhoff Industrial Electronics CP-Link PC Multiplexer as described in U.S. Pat. No. 6,684,264 entitled Method of Simplifying Machine Operation, which is fully incorporated herein by reference. The display 24 may include a touch screen display which may be configured to display information representing various parameters of the selected GUI. For example, one or more portions of the touch screen display 24 may be configured to represent various buttons and/or functions of the selected GUI such as, but not limited to, the display, pointing devices, pushbuttons, as well as graphical icons, visual indicators or special graphical elements called “widgets”, along with text, labels or text navigation to represent the information and actions available to a user and to provide the functions for data entry, screen selections, machine operation selection and actuation of manual operations. The size, shape, and/or location of the various portions of the touch screen display 24 may be assigned based on the selected GUI format.

An I/O bus controller 42 may be coupled to the host bus 36 and field bus 44. The computer 30 also includes a local area network interface 46 which may be coupled to a local area network (e.g., Ethernet 48) used within the factory. Also, the computer 30 may include a modem or other external interface 50 which may be used to connect the computer 30 to, e.g., the internet or an intranet 52 and ultimately to another computer or server 54. The control computer 30 may also comprise a variety of other computer components.

The memory 34 may also include a database 56 of a plurality of pieces of IMM equipment and a plurality of GUIs formats. For example, the database 56 may include the list of GUI formats from which the user may select as generally described above in (e.g., 110 in FIG. 2). Additionally, the database 56 may also include the list of pieces of IMM equipment from which the user may select as generally described above (e.g., 120 in FIG. 2).

The machine controller 14a may also be configured to update the database 56 from an external source by way of the local area network interface 46 and/or the modem or other external interface 50. For example, the machine controller 14a may access a server 54 containing a list of IMM equipment 16a-16n and/or GUI formats across the Internet 52. While the database 56 is shown as part of the machine controller 14a, the database 56 may also be part of an external server/computer 54. For example, the machine controller 14a may be configured to access the database 56 on the external server 54 whenever requested by the user and/or periodically. The control program 38 executed by the processor 32 may be configured to send and/or receive signals to/from the control panel interface 40 which may then configure the display 24 and/or the I/O devices 26 to simulate and/or represent a selected GUI format. For example, the control program 38 executed by the processor 32 may be configured to send signals to the control panel interface 40 which may then assign certain areas of a touch-screen display 24 and/or assign certain buttons and/or I/O devices 26 to represent at least part of the selected GUI format such as, but not limited to, pointing devices, pushbuttons, as well as graphical icons, visual indicators or special graphical elements called “widgets”, along with text, labels or text navigation to represent the information and actions available to a user and to provide the functions for data entry, screen selections, machine operation selection and actuation of manual operations. The control program 38 executed by the processor 32 may also be configured to send and/or receive signals to/from the I/O bus controller 42 for controlling and/or monitoring the operation and/or processes of one or more pieces of the IMM equipment 16a-16n. The control program may be configured to create the necessary relationships and translate signals between the GUI and the IMM equipment 16a-16n.

As mentioned above, the present disclosure is not intended to be limited to a system or method which must satisfy one or more of any stated or implied object or feature of the invention and should not be limited to the preferred, exemplary, or primary embodiment(s) described herein. The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as is suited to the particular use contemplated. All such modifications and variations are within the scope of the invention as determined by the claims when interpreted in accordance with breadth to which they are fairly, legally and equitably entitled.

The invention claimed is:

1. A method of controlling a piece of molding machine equipment comprising:
selecting at least one piece of molding machine equipment forming at least part of a molding machine;
selecting at least one graphical user interface format (GUI) from a plurality of GUI formats; and
configuring a GUI of a machine controller to control said selected piece of molding machine equipment based on said selected GUI format.

2. The method of claim 1, wherein configuring said GUI of said machine controller comprises configuring said GUI to substantially simulate said selected GUI format.

3. The method of claim 2, wherein configuring said GUI of said machine controller comprises configuring at least a portion of a display to substantially simulate at least a portion of said selected GUI format.

4. The method of claim 3, wherein configuring said display comprises configuring at least a portion of a touch screen display to substantially simulate at least a portion of said selected GUI format.

5. The method of claim 1, further comprising selecting said at least one GUI format from a list comprising a plurality of GUI formats, each of said GUI formats associated with at least one piece of molding machine equipment by a manufacturer of said piece of molding machine equipment.

6. The method of claim 5, wherein selecting said GUI format further comprises selecting a GUI format that is different from a GUI format created by a manufacturer of said selected piece of molding machine equipment.

7. A method of controlling a piece of molding machine equipment comprising:
presenting to a user a first set of pieces of molding machine equipment;
presenting to said user a set of graphical user interface (GUI) formats associated with a second set of molding machine equipment by at least one manufacturer of said second set of molding machine equipment;
selecting at least one piece of molding machine equipment to be controlled by said molding machine control apparatus from said first set of pieces of molding machine equipment;
selecting a GUI format from said set of GUI formats; and
configuring a GUI of a machine controller to control said selected piece of molding machine equipment based on said selected GUI format.

8. The method of claim 7, wherein configuring said GUI of said machine controller comprises configuring said GUI to substantially simulate a selected GUI format.

9. The method of claim 8, wherein configuring said GUI of said machine controller comprises configuring at least a portion of a display to substantially simulate at least a portion of said selected GUI format.

10. The method of claim 9, wherein configuring said display comprises configuring at least a portion of a touch screen display to substantially simulate at least a portion of said selected GUI format.

11. The method of claim 7, wherein selecting said GUI format further comprises selecting a GUI format that is different from a GUI format created by a manufacturer of said selected piece of molding machine equipment.

12. An article comprising a storage medium having stored thereon instructions that when executed by a machine result in the following:
presenting to a user a first set of pieces of molding machine equipment;
presenting to said user a set of graphical user interface (GUI) formats associated with a second set of pieces of molding machine equipment by at least one manufacturer of said second set of pieces of molding machine equipment;
selecting at least one piece of molding machine equipment to be controlled by said molding machine control apparatus from said first set of pieces of molding machine equipment;
selecting a GUI format from said set of GUI formats; and
configuring a GUI of said machine controller to control said selected piece of molding machine equipment based on said selected GUI format.

13. The article of claim 12, wherein configuring said GUI of said machine controller comprises configuring said GUI to substantially simulate a selected GUI format.

14. The article of claim 13, wherein configuring said GUI of said machine controller comprises configuring at least a portion of a display to substantially simulate at least a portion of said selected GUI format.

15. The article of claim 14, wherein configuring said display comprises configuring at least a portion of a touch screen display to substantially simulate at least a portion of said selected GUI format.

16. The article of claim 12, wherein selecting said GUI format further comprises selecting a GUI format that is different from a GUI format created by said manufacturer of said selected piece of molding machine equipment.

17. A system comprising:
at least one piece of molding machine equipment forming at least part of a molding machine system; and
a machine controller comprising:
a display; and
a storage medium having stored thereon instructions that when executed by said machine controller, result in configuring a graphical user interface (GUI) of said machine controller to control said at least one piece of molding machine equipment based on a user selection of a GUI format.

18. The system of claim 17, wherein said instructions further result in the following:
presenting to a user a first set of pieces of molding machine equipment;
presenting to said user a set of GUI formats associated with a second set of pieces of molding machine equipment by at least one manufacturer of said second set of molding machine equipment;
selecting a piece of molding machine equipment to be controlled by said molding machine control apparatus from said first set of pieces of molding machine equipment; and
selecting a GUI format from said set of GUI formats, wherein said selected GUI format is different from a GUI format created by a manufacturer of said selected piece of molding machine equipment.

19. A machine controller apparatus comprising:
a display; and
a storage medium having stored thereon instructions that when executed by said machine controller, result in configuring a graphical user interface (GUI) of said machine controller to control said at least one piece of molding machine equipment based on a user selection of a GUI format.

20. The apparatus of claim 19, wherein said instructions further result in the following:
presenting to a user a first set of pieces of molding machine equipment;
presenting to said user a set of GUI formats associated with a second set of pieces of molding machine equipment by at least one manufacturer of said second set of pieces of molding machine equipment;
selecting a piece of molding machine equipment to be controlled by said molding machine control apparatus from said first set of pieces of molding machine equipment; and
selecting a GUI format from said set of GUI formats, wherein said selected GUI format is different from a GUI format created by a manufacturer of said selected piece of molding machine equipment.
